(19) United States
(12) Patent Application Publication
(10) Pub. No.: US 2007/0003669 A1
(43) Pub. Date: Jan. 4, 2007

(54) FUCOIDAN DELIVERY SYSTEM

(76) Inventors: Troy Kearl, Sandy, UT (US); Mina Kearl, Sandy, UT (US)

Correspondence Address: RANDALL B. BATEMAN;BATEMAN IP LAW GROUP, 8 EAST BROADWAY, SUITE 550, PO BOX 1319, SALT LAKE CITY, UT, 84110, US

(21) Appl. No.: 11/421,719

(22) Filed: Jun. 1, 2006

Related U.S. Application Data
(60) Provisional application No. 60/686,908, filed on Jun. 2, 2005.

(51) Int. Cl. A23L 1/30

(52) U.S. Cl. 426/72; 426/573

(57) ABSTRACT

A fucoidan gel and fucoidan gel delivery system for nutritional supplements are provided. A gel may be formed with fucoidan and eaten by a person so as to provide beneficial fucoidan to the person. The fucoidan gel may further be used as a delivery system wherein nutritional supplements such as vitamins are dissolved or suspended in the fucoidan gel and provided to a person. The fucoidan gel may easily be flavored and altered in consistency so as to provide a food product which is appealing to the palate.

### RELATED APPLICATIONS

The present application claims the benefit of U.S. Provisional Application Ser. No. 60/686,908, filed Jun. 2, 2005, which is incorporated herein in its entirety.

### BACKGROUND OF THE INVENTION

1. The Field of the Invention

The present invention relates to nutritional supplements. More specifically, the present invention relates to a Fucoidan Delivery System for providing nutritional fucoidan and for providing additional beneficial vitamins, minerals, and the like.

2. State of the Art

Nutritional supplements such as vitamins and minerals have traditionally been provided in the form of capsules and tablets. The vitamin which is to be provided to an individual is compressed or otherwise formed into a pill as is suited for each particular vitamin. Powdered vitamins are often mixed with a binder to facilitate compression into a pill. Liquid vitamins may be mixed with sufficient binder to harden the liquid into a rubbery material. This method of delivering vitamins and minerals allows many different vitamins to be provided to individuals desiring such vitamins.

A drawback of such vitamin tablets is that the tablets typically are not fully broken down or digested and utilized by the body. As much as seventy percent or more of the vitamin may not be utilized, and passes out of the body unused. This occurs both because the body is often unable to fully break down the tablets and extract the vitamins, or because the vitamins are provided in a form which is less usable by the human body, but more easily formed into a pill. This may occur with all types of vitamin pills.

Another drawback of vitamin pills is the frequently disagreeable taste of the pill. Many people do not like the taste or residual aftertaste of vitamin pills. Thus, pills are not an optimum method for delivering vitamins and minerals to an individual.

Some vitamins or supplements are thus provided in an alternate form. Some powders are placed in a dissolvable gelatin capsule to thereby form a tablet. The powder is made more readily available as it is not held together with binders or tightly compressed into a tablet. Such vitamins, however, often retain a unpleasant flavor, and are not suited for liquid vitamins.

Other powders are provided in a bulk quantity of powder which a person must mix into a beverage to consume. Such powders often retain an undesirable taste, and often impart an undesirable gritty texture to the beverage. Additionally, a person using such powders must typically measure the powder and separate an individual portion from the larger quantity of powder. Such is inconvenient, and may dissuade persons from such a vitamin or supplement.

Liquid vitamin drinks are provided, typically by mixing some desirable vitamins into a liquid form. Such vitamins are often used by individuals who have difficulty swallowing pills. These liquid vitamins, however, often retain an unpleasant taste and texture which dissuade individuals from using the vitamins/minerals. Additionally, liquid vitamins typically are provided in a large bottle and not in single doses which may be more easily used.

It is appreciated that many of the vitamin or supplement forms which require a person to measure out a single portion from a larger container are somewhat inconvenient to use. They are more difficult for a person to carry, such as when going on a trip or even when carrying vitamins to be taken when a person is away from home. In such a situation it is convenient to have a vitamin which is in a single dosage and which may be easily consumed without additional food or drink.

While vitamins are often unpleasant to adults, many adults are nevertheless willing to take the vitamins. Children, however, are often unwilling to take vitamins because of the taste or form of delivery of the vitamins.

Another limitation of present vitamins or supplements is that the substance used to aid in consuming the vitamin is often juice, water, etc. It would be beneficial to persons if the vitamins or supplements were consumed in a carrier which was also a beneficial supplement.

There is thus a need for a vitamin delivery system which overcomes the limitations of available vitamins. Specifically, there is a need for a vitamin delivery system which provides vitamins in a form which is readily assimilated by the body, in a convenient form, and which provides a pleasant flavor and texture to the individual taking the vitamin.

### SUMMARY OF THE INVENTION

It is an object of the present invention to provide an improved delivery system for vitamins, minerals, and other nutritionally beneficial substances. It is a further object of the present invention to provide nutritionally beneficial fucoidan to individuals.

According to one aspect of the invention, a method of providing nutritional fucoidan is provided. Fucoidan, an extract from brown seaweed, may be provided in a gel with the fucoidan forming at least a portion of the gelling agent. The gel may be thickened to a varying degree and flavored as is desired. Accordingly, the fucoidan gel may be provided in varying forms such as a gel drink or a gel dessert.

According to another aspect of the invention, a delivery system is provided for vitamins, minerals, and other supplements. Desired supplements, such as vitamins, may be provided in a fucoidan gel. The supplements may thus be provided in a form which is easily assimilated by the body. The supplements may also be provided in a form which has a desirable taste and texture.

These and other aspects of the present invention are realized in a fucoidan delivery system as shown and described in the following figures and related description.

### BRIEF DESCRIPTION OF THE DRAWINGS

Various embodiments of the present invention are shown and described in reference to the numbered drawings wherein:

FIG. 1 shows a perspective view of a bottle of fucoidan gel according to the present invention;

FIG. 2 shows a perspective view of a container of fucoidan gel according to the present invention; and

FIG. 3 shows a perspective view of a pouch of fucoidan gel according to the present invention.

It will be appreciated that the drawings are illustrative and not limiting of the scope of the invention which is defined by the appended claims. The various embodiments shown accomplish various aspects and objects of the invention.

### DETAILED DESCRIPTION

The invention and accompanying drawings will now be discussed in reference to the numerals provided therein so as to enable one skilled in the art to practice the present invention. The drawings and descriptions are exemplary of various aspects of the invention and are not intended to narrow the scope of the appended claims.

Brown seaweed has long been used as a nutritious food. Brown seaweed has been associated with enhanced immune systems and decreased gastro-intestinal problems. Thus, it is widely used in Aisa. It has more recently been discovered that some compounds found in brown seaweed, such as fucoidan, have beneficial effects in the human body. Although many individuals like the taste of seaweed, perhaps a larger amount of individuals dislike the taste of seaweed and prefer not to consume it as a food. These individuals, however, could benefit from the beneficial nutrients such as fucoidan which are found in the seaweed.

Seaweed may be processed to extract and purify fucoidan. The fucoidan may then be provided as a nutritional supplement. Fucoidan possess many beneficial properties as a nutritional supplement. Fucoidan is believed to promote well-being, enhance the immune system, and aid the body in fighting illness. As a substance, hydrated fucoidan has a somewhat slimy feel.

According to the present invention, fucoidan may be provided in a gel or jelly form. Fucoidan has some thickening properties, and will act in a manner similar to gelatin or other thickening agents when mixed into many liquids. Varying amounts of fucoidan in a liquid such as water will thus provide varying degrees of thickness in the resulting gel.

The fucoidan may be obtained form various types of algae and seaweed, and the fucoidan supplement may also be mixed with other components or parts of the algae and seaweed. Such algae and seaweed may include Kombu (laminaria), Wakame (undaria pinnatifida), Mozuku (nemacystus decipens), Hijiki (Hedwigiaceae), or the like.

It has been determined that a beneficial daily dose of fucoidan is about 300 mg, or possibly more, depending on personal preferences, desires, and needs of the individual. Thus, 300 mg or more of fucoidan may be mixed with a relatively small amount of liquid to form a thick gel which may be consumed by an individual. Such a method of delivery is advantageous as the resulting fucoidan supplement is small and may be provided in a thin or relatively small envelope or pouch. Accordingly, a single serving of fucoidan gel nutritional supplement may be formulated to provide at least 100 mg of fucoidan, more preferably at least 200 mg of fucoidan, and more preferably at least 300 mg of fucoidan.

Alternatively, the daily dose of fucoidan may be mixed into a larger amount of liquid resulting in a softer gel. The gel may even be thin enough to drink. It will be appreciated that it may be desirable to provide a single serving amount of fucoidan gel which is thicker than is possible to achieve when using only fucoidan as a thickener. The gel may then be thickened with additional thickeners, such as seaweed extracts, gelatin, corn or potato starches, carrageenan, agar, or gum thickeners such as xanthan gum. The fucoidan may thus be provided in a larger serving which may be consumed with a meal or as a snack.

The fucoidan gel may also be flavored as is desired to provide a taste which is pleasing to the consumer. While seaweed has a strong and distinct flavor that many find unpalatable, purified fucoidan retains very little flavor. Thus, any desired flavoring may be added to the fucoidan. Fruit flavors may be added to the fucoidan gel to provide a refreshing fruit taste similar to gelatin. Sugar may also be added to the gel to sweeten the gel as is desired. In such a form, it is relatively easy to get a child to eat fucoidan.

Thus, a fucoidan gel supplement is provided which may be made in several different forms. A fucoidan supplement may be provided as a small packet of thickened fucoidan gel, a fucoidan gel dessert, a fucoidan gel drink, etc. The fucoidan supplement may be flavored as desired. A wide variety of fruit flavors such as banana, strawberry, grape, lime, pineapple, raspberry, mixed berry, tropical punch, etc., or other flavors such as chocolate or vanilla may be used. A delivery system is thus provided whereby a nutritionally beneficial fucoidan supplement is provided to an individual. The delivery system provides fucoidan to the individual in a manner which avoids the problems of available vitamin and supplement delivery systems, including undesirable taste and texture, and low availability and absorption of the supplement by the body.

According to another aspect of the present invention, the fucoidan gel provides a delivery system for additional vitamins, minerals, and other supplements. As previously discussed, there are several limitations to currently available methods for providing nutritional supplements and vitamins. Compressed pills or tablets are inefficient methods of delivering vitamins and supplements as the body can not easily break down the tablet and absorb the supplement. The tablets typically have an undesirable taste. Gelatin capsules containing a powdered supplement commonly have an undesirable taste. Liquid vitamins often have an undesirable chalky or medicine taste.

Many supplements or vitamins are more easily digested and absorbed as a liquid or a more finely divided solid than as a large solid such as a tablet. Vitamins in liquid form may be easily and more completely absorbed by the body. Liquids loosely bound into a gel are also easily absorbed into the body. Fucoidan may thus be used as a gelling agent and delivery system for providing liquid vitamins. Additionally, fucoidan gel may be used as a suspension medium for finely powdered or palletized vitamins or supplements, providing a delivery system for solid supplements. The fucoidan gel as previously discussed is thus an ideal delivery system for additional vitamins and other supplements.

While liquid vitamins are typically not available as a single dose and are inconvenient to use, fucoidan gel may be easily formed as a single dose and packaged into easy to use packets. The packets may be small envelopes which are as easily stored or carried as vitamin tablets. The fucoidan packets may also be elongate tubes such as are used for string cheese or yogurt, as children will find such packaging entertaining to use.

The fucoidan gel, which may be flavored, provides a delivery system which can easily mask the sometimes unpleasant flavor of a vitamin, mineral, or other supplement. Thus, the vitamins as provided in a fucoidan delivery system may be made to taste like fruit or any other desired flavor. The vitamins may thus be made to taste like a snack. Children will thus desire to eat the fucoidan gel and vitamins as it will taste to them as a dessert or snack, and no mention need be made that they are taking a vitamin or nutritional supplement. Additionally, children are entertained by novel packaging of food items, as is manifested by string cheese, rolled fruit leather shacks, chewy fruit snacks, yogurt pouches, etc. The packaging of the fucoidan gel and vitamins in a elongate pouch makes the packaging of the gel as desirable to the child as the flavor. The present invention thus provides a method for providing vitamins to a child whereby the child will desire to eat the vitamins, minerals, or other supplements and whereby the vitamins are more readily absorbed and utilized by the child.

The present invention also provides a method for delivering a large variety of vitamins, minerals, and other supplements to an individual. As discussed, liquid vitamins may be delivered to an individual by mixing the vitamins into a fucoidan gel. Additionally, supplements which are not available in a liquid form may also be delivered via a fucoidan gel. A supplement such as a vitamin which is a solid may be finely ground or formed as pellets and mixed into a fucoidan gel. The viscosity of the gel is typically sufficient to maintain the powder in suspension. A finely ground powder or palletized material suspended in a fucoidan gel is more available to the body and thus advantageous as compared to vitamin tablets.

While a vitamin tablet is often not fully broken down by the body, the finely ground powder or pellets in the fucoidan gel is presented to the body as smaller particles, and can be more readily absorbed. A finely ground powder or pellets provides much greater surface area than the same weight of the supplement in larger pieces, allowing the finely ground powder to be digested and absorbed more quickly and completely by the body. Thus, many, if not all supplements may be delivered via a fucoidan gel, providing a supplement which is typically better utilized by the body and which has an appealing flavor and texture.

Many different supplements may be delivered via a fucoidan delivery system as detailed in the present invention. Various supplements such as vitamins C, B, A, E, beta carotene, herbs, amino acids, enzymes, immune boosters, etc. may all be delivered via fucoidan gel. While many of these supplements may retain some undesirable flavor, the fucoidan gel may impede the permeation of the flavor into the gel, or may lessen the contact between the supplement and a person's tongue as the gel is eaten.

The fucoidan gel may be formulated as a supplement to not only deliver nutritional fucoidan, but to deliver supplements specific to a particular condition or result. A fucoidan gel may be utilized to deliver supplements for general health, energy and alertness, skin health, bone health, joint health, anti-cancer, anti-aging, etc.

Supplements or additives added to the fucoidan may include turmeric, oyster extract, nutritional yeast extract, ashitaba, royal jelly, garlic, aloe, milk thistle seed extract, cordyceps sinensis, St. Johns wort, SAMe, red yeast rice, kefir, mulberry extract, caffeine, plant extracts, herbs, minerals, amino acids, etc.

Supplements for skin may include CoQ10, collagen, hyaluronic acid, chondoitin sulfate, isoflavone, calcium, suguarene, royal jelly, dermatan sulfate, oligo saccharide, L-cystin, toco trienol, and ceramide. Supplements for anti-cancer or anti-aging may include active hexose correlated compounds, agaricus, reishu maitake, and meshimakobu shitake. Supplements for cardiovascular health may include nattokinase, DHA, EPA, and red rice yeast. Supplements for diabetes may include mulberry extract and gymnema sylvestre. Supplements for bone health may include minerals, colloidal minerals, brewer's yeast, biotin, chitosan, lutein, choline, and lycopene. Supplements for energy or weight loss may include caffeine, CoQ10, glucomannan, agar, lipoic acid, carmitin, and the like. It is appreciated that a formulation may include supplements to achieve a combination of benefits or address a combination of health issues, such as improving bone health and joint health, or improving cardiovascular health as well as fighting cancer or aging.

It is thus seen that the fucoidan is an advantageous delivery mechanism for delivering the above mentioned supplements, as the supplements may be provided as pellets or divided powders, liquids, mini capsules, etc and suspended in the fucoidan gel. As is discussed, the fucoidan may be used to minimize any disagreeable taste of the supplements, and may include flavors chosen to mask any disagreeable tastes and provide a supplement which is appealing to the consumer. The fucoidan thus becomes both a nutritional supplement and a delivery mechanism for additional nutritional supplements.

In a prefered embodiment, the gel comprises at least 25% of the volume of the supplement. In a more preferred embodiment, the gel comprises at least 50% of the supplement, and in a still more preferred embodiment, the gel comprises at least 75% of the supplement. Additionally, it is appreciated that the gel may be a mixture of fucoidan and other gel agents to provide the desired consistency and volume of gel. In a preferred embodiment, the gel is largely fucoidan gel.

The fucoidan may thus be provided in a single dose package which is easily consumed by a user, and which has an agreeable taste. Fucoidan is known in a posdered tablet form to be consumed by a person, but has the limitations of taste, swallowability, and absorbability associated with tablets and discusses previoysly. As a gel according to the present invention, the fucoidan may be flavored to have an agreeable taste and formulated to be easily consumed.

Additionally, the gel may be flavored as previously discussed. Practically limitless different flavors are available. The flavor may even be selected according to the supplements which are in the fucoidan gel. For example, a supplement may have a flavor which is better masked by a cherry flavor or by a mint flavor. Another supplement may be better masked by a banana flavor. Some supplements may be masked by a soft flavor such as vanilla, cotton candy, apple, etc. while other supplements may be better masked by a stronger flavor such as sour apple, raspberry, fruit punch, mint, etc. Varying amounts or sweeteners may be used according to the flavor, supplement, or targeted consumer.

Some examples of flavors which may be used include: peach, pear, apricot, plum, sour apple, apple, cherry, kiwi, orange, lemon, lime, grapefruit, banana, mango, passion fruit, papaya, pineapple, grape, watermelon, raspberry, blackberry, blueberry, cranberry, strawberry, fig, coconut, fruit mixtures such as fruit punch, tropical punch, mixed berry, vanilla, chocolate, butterscotch, nut flavors such as almond, pistachio, walnut, peanut, various mint flavors, etc.

The gel may also be colored according to the flavor which is used. As fucoidan gel is naturally a light brown, it will often be desirable to color the gel as may be more appealing to the particular consumer. Children, for example, typically desire brightly colored items. A novelty food item such as a gel stick or jelly straw would likely be brightly colored. Adults may often desire more muted or subdued colors, as such may be viewed as more healthy.

The following figures and discussion thereof provide examples of how the fucoidan gel may be packaged. For clarity and brevity the above discussion of the use of fucoidan is not repeated in reference to each figure, but applies to each figure as general principles of the usage of fucoidan. It is further understood that the principles of the usage of fucoidan as discussed below also typically apply to the various packaging methods, and as such apply to the example shown in each figure.

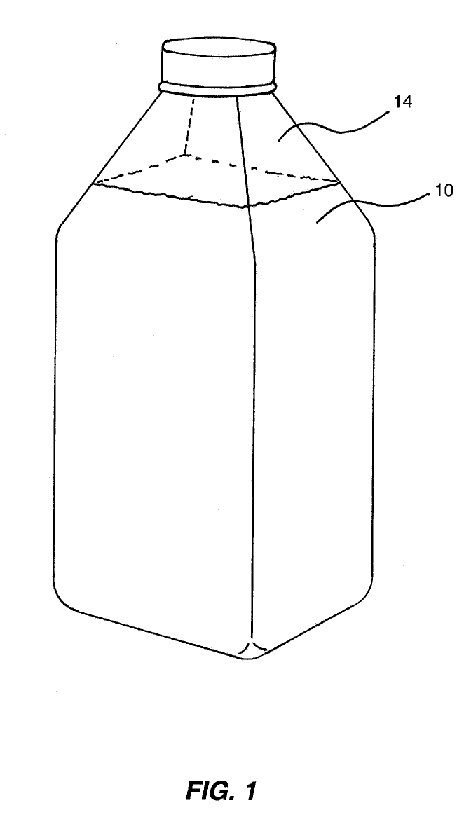

Turning to FIG. 1, a perspective view of a bottle of fucoidan gel according to the present invention is shown. According to aspects of the present invention, a gel or jelly drink 10 may be provided which uses fucoidan as a thickener. The drink 10 would typically be provided in a bottle 14, although other containers are equally suitable. The drink 10 may be provided in a multiple portion bottle 14 which is convenient for home use, or may be provided in single serving bottles 14 or pouches (as are used for children's drinks) which are convenient for consumption away from home. Single portion bottles 14 or pouches are ideal for providing vitamins to children, as the vitamins may be provided in a drink which the children enjoy.

The gel drink 10 may be provided in varying thicknesses by adjusting the amount of fucoidan and other thickeners as previously discussed. Additionally, the drink 10 may be formed so as to be easily mixed with other liquids, such as another drink, should the consumer desire to alter the flavor or thickness of the drink 10. In addition to providing beneficial fucoidan in a form which is pleasing in taste and texture, the drink may also be used to deliver other supplements in a powdered or liquid form as previously discussed.

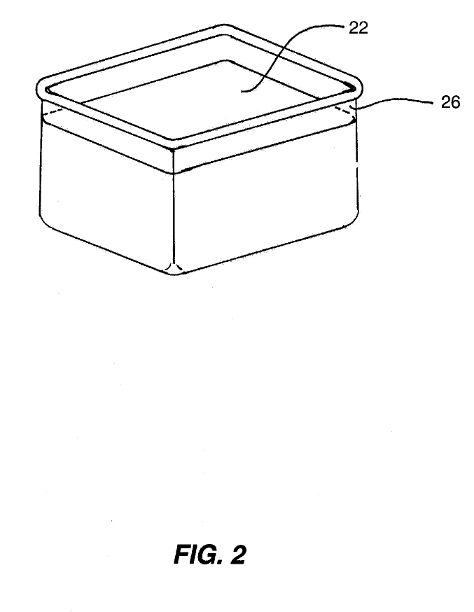

Turning now to FIG. 2, a perspective view of a fucoidan gel according to the present invention is shown. The fucoidan gel has been made sufficiently thick, preferably by adding sufficient fucoidan or a mixture of fucoidan and other thickeners, so as to be eaten with a spoon as a desert or snack. The fucoidan gel 22 may thus be packaged in single serving desert cups 26. The fucoidan gel 22 may be used as a delivery system for vitamins and other supplements as previously discussed, allowing a consumer to ingest desirable supplements with a delicious snack. The fucoidan gel 22 may be provided with a school lunch, thereby providing vitamins to a child in a form likely to be eaten by the child.

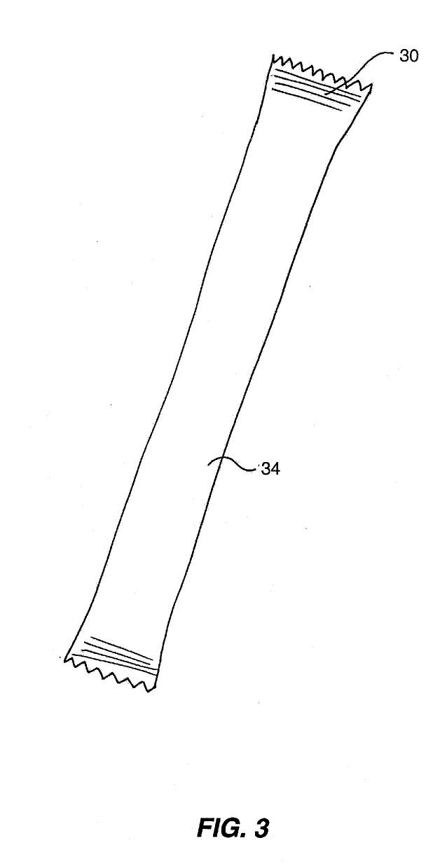

Turning now to FIG. 3, a perspective view of a pouch containing fucoidan gel according to the present invention is shown. According to one aspect of the present invention, the fucoidan gel may be formed in a consistency similar to a gelatin dessert or somewhat thinner, allowing an individual to open an end 30 of the pouch 34 and squeeze the fucoidan gel out of the pouch 34 to eat the gel. The pouch 34 is typically elongate as shown, although other proportions may be used. Elongate pouches 34 are popular with children as the pouches 34 allow the children to enjoy squeezing the fucoidan gel out of the pouch 34.

Pouches 34 of fucoidan gel may be creatively marketed to children by using names such as jelly straw and by using colorful packaging and attractive pictures on the package. The pouch 34 of fucoidan gel thus becomes something that the children desire to eat, making it easier for parents to ensure that the children are eating the vitamins and supplements which may be placed in the fucoidan gel.

The fucoidan gel pouches 34 may also be frozen, providing a unique frozen dessert. The frozen fucoidan gel retains some of the gel characteristics, such as the slippery texture, which provide a unique experience to the consumer as the frozen fucoidan gel is eaten. It will thus be appreciated that by using a fucoidan gel delivery system, there exist many ways to provide a nutritionally beneficial substance which appeals to the appetite of both adults and children alike.

It will be appreciated that many different applications exist for a fucoidan delivery system as discussed. Fucoidan gel may be used to deliver children's vitamins, daily vitamins, energy supplements, anti-oxidant supplements, weight loss products, etc. The fucoidan gel provides a beneficial delivery system as it provides beneficial fucoidan to the consumer, and also allows additional supplements to be delivered in a liquid or finely powdered form which are more readily assimilated by the body. It will be appreciated that many different types of supplements are suitable for delivery using a fucoidan delivery system as discussed.

According to the present invention, fucoidan gel is also beneficial as a topical skin cream and as a delivery system for additional topically applied agents. A fucoidan gel applied to the skin will be absorbed into the skin and leaves little residue. The fucoidan gel is beneficial to the skin as it can help soften and heal the skin. A fucoidan gel may also be beneficial as a delivery system wherein additional vitamins and supplements beneficial to the skin are dissolved or suspended in the fucoidan gel. As the fucoidan gel is applied to the skin and absorbed by the skin, the beneficial supplements are also absorbed into the skin.

There is thus disclosed an improvement in a fucoidan gel and delivery system. It will be appreciated that numerous changes may be made to the present invention without departing from the scope of the claims.

What is claimed is:

1. A nutritional supplement comprising:
a gel having fucoidan therein.

2. The supplement of claim 1, wherein the nutritional supplement is packaged in a single serving container.

3. The supplement of claim 1, further comprising a flavoring or coloring agent.

4. The supplement of claim 1, wherein the supplement further comprises at least one liquid vitamin, mineral, or supplement added to the gel.

5. The supplement of claim 1, wherein the supplement further comprises at least one powdered vitamin, mineral, or supplement added to the gel.

6. The supplement of claim 1, wherein the gel comprises a liquid mixed with the fucoidan.

7. The supplement of claim 1, wherein the gel comprises an additional thickener mixed with the fucoidan.

8. The supplement of claim 1, wherein the nutritional supplement is frozen.

9. The supplement of claim 1, wherein the supplement contains at least 100 mg of fucoidan in a single serving.

10. The supplement of claim 1, wherein the supplement contains at least 200 mg of fucoidan in a single serving.

11. The supplement of claim 1, wherein the supplement contains at least 300 mg of fucoidan in a single serving.

12. The supplement of claim 1, wherein the supplement comprises a at least one vitamin, mineral or nutritional supplement added to the gel, and wherein the gel comprises at least 25% of the resulting mixture by volume.

13. The supplement of claim 1, wherein the supplement comprises a at least one vitamin, mineral or nutritional supplement added to the gel, and wherein the gel comprises at least 50% of the resulting mixture by volume.

14. The supplement of claim 1, wherein the supplement comprises a at least one vitamin, mineral or nutritional supplement added to the gel, and wherein the gel comprises at least 75% of the resulting mixture by volume.

15. The supplement of claim 1, wherein the supplement comprises a at least one vitamin, mineral or nutritional supplement added to the gel, and wherein the fucoidan gel comprises at least 50% of the resulting mixture by volume.

16. A method for delivering a nutritional supplement to a person comprising:
forming a gel, the gel comprising a liquid and fucoidan;
disposing the nutritional supplement in the gel; and
providing the gel to be eaten by the person.

17. The method of claim 16, wherein the method further comprises placing the gel into a pouch.

18. The method of claim 16, wherein the method comprises giving the gel to a person as a snack or dessert.

19. The method of claim 16, wherein the nutritional supplement is suspended in the gel.

20. The method of claim 19, wherein the nutritional supplement comprises a powder.

21. The method of claim 19, wherein the nutritional supplement comprises pellets.

22. The method of claim 16, wherein the gel comprises at least 25% of the resulting nutritional supplement by volume.

23. The method of claim 16, wherein the gel comprises at least 50% of the resulting nutritional supplement by volume.

24. The method of claim 16, wherein the gel comprises at least 75% of the resulting nutritional supplement by volume.

25. The method of claim 16, wherein the method comprises packaging the nutritional supplement in a single serving package.

26. The method of claim 25, wherein the single serving of the nutritional supplement comprises at least 100 mg of fucoidan.

27. The method of claim 25, wherein the single serving of the nutritional supplement comprises at least 200 mg of fucoidan.

28. The method of claim 25, wherein the single serving of the nutritional supplement comprises at least 300 mg of fucoidan.

29. A method for delivering a supplement comprising;
selecting a gel comprising fucoidan; and
applying the gel to the skin.

30. The method of claim 29, wherein the gel further comprises at least one vitamin, mineral, supplement, or the like

31. The method of claim 29, wherein the gel further comprises a liquid mixed with the fucoidan.

32. A method for delivering a nutritional supplement comprising:
selecting a fucoidan gel;
mixing a desired supplement into the fucoidan gel; and
providing the gel for consumption.

33. The method of claim 32, wherein the method further comprises suspending the supplement into the fucoidan gel.

34. The method of claim 32, wherein the method further comprises flavoring the fucoidan gel to mask the flavor of the supplement.

35. The method of claim 32, wherein the supplement comprises a powder.

36. The method of claim 32, wherein the supplement comprises pellets.

37. The method of claim 32, wherein the method further comprises packaging the nutritional supplement in a single serving package.

38. The method of claim 37, wherein the single serving of the nutritional supplement comprises at least 200 mg of fucoidan.

39. The method of claim 37, wherein the single serving of the nutritional supplement comprises at least 300 mg of fucoidan.

40. The method of claim 32, wherein the nutritional supplement comprises at least 25% fucoidan gel.

41. The method of claim 32, wherein the nutritional supplement comprises at least 50% fucoidan gel.

42. The method of claim 32, wherein the nutritional supplement comprises at least 75% fucoidan gel.
